(19) United States
(12) Patent Application Publication
(10) Pub. No.: US 2026/0178847 A1
(43) Pub. Date: Jun. 25, 2026

(54) SYSTEM AND METHOD OF GENERATING CONTEXTUALLY RELEVANT PROMPTS FOR GENERATIVE ARTIFICIAL INTELLIGENCE BASED TOOLS

(71) Applicant: Cognizant Technology Solutions India Pvt. Ltd., Siruseri (IN)

(72) Inventors: Madhusudhan Venkatesan, Chennai (IN); Pramod Bijani, Mumbai (IN); Trichur Krishnan Narayanan, Chennai (IN); Suman Kumar Singh, North 24 Parganas (IN)

(21) Appl. No.: 19/426,650

(22) Filed: Dec. 19, 2025

(30) Foreign Application Priority Data
Dec. 20, 2024 (IN) 202441101167

(51) Int. Cl. G06F 40/40; G06F 40/174; G06F 40/186; G06F 40/30; G06N 3/0475

(52) U.S. Cl. CPC G06F 40/40; G06F 40/174; G06F 40/186; G06F 40/30; G06N 3/0475

(57) ABSTRACT

A system and a method for generating contextually relevant prompts for Gen AI tools are disclosed. A user input corresponding to a data object is received for determining object characteristics. A plurality of pre-determined categories is determined from a pre-defined prompt library database based on the determined object characteristics, which is rendered for selection by a user. A plurality of pre-determined sub-categories is determined from the pre-defined prompt library database based on a selected pre-determined category from amongst the plurality of pre-determined categories and the plurality of pre-determined sub-categories is rendered for selection by the user. A selected pre-determined sub-category is transformed by inserting contextual data received from the user and the prompts are generated based on the transformed pre-determined sub-category.

### FIELD OF THE INVENTION

The present invention relates generally to the field of processing and transformation of data, and more particularly, relates to a system and a method for generating contextually relevant prompts for generative artificial intelligence based tools and enabling efficient and accurate execution of tasks.

### BACKGROUND OF THE INVENTION

In large-scale software development environments, organizations are increasingly relied on various artificial intelligence systems to accelerate development workflows and improve code quality. For example, code suggestion engines 124 such as GitHub Copilot®, Amazon Q®, and Tabnine®, Gemini®, Claude® are used for code generation to execute various tasks. A code suggestion engine generates code fragments or recommendations as outputs in response to prompts provided by software developers. The accuracy, contextual relevance, and reliability of the generated outputs are significantly dependent on the quality of the prompts formulated by the developers.

Typically, in modern software development ecosystems, multiple teams work concurrently on various projects within an Integrated Development Environment (IDE). In such distributed environments, prompt engineering practices frequently evolve in an uncoordinated manner as individual developers create different custom prompts for identical or similar use cases, which results in inconsistencies in prompt formulation, duplication of effort, and overall inefficiencies during Software Development Lifecycle (SDLC) within the IDE. The existing approaches do not enforce or facilitate uniformity in creation, structure, or application of the prompts. Consequently, developers within same team or across different teams generate prompts that vary widely in clarity, completeness, and adherence to organizational best practices, thereby leading to inconsistent outputs from the code suggestion engine and impedes maintenance of uniform development standards within the IDE environment. As such, the existing approaches lack standardization in prompt suggestions while developing or maintaining software within IDEs.

Furthermore, the existing approaches require developers to create prompts manually within the IDEs. Such manually created prompts are usually incomplete, ambiguous, and lack sufficient contextual information for the code suggestion engine to generate output. Also, the effectiveness of the code suggestion engine largely depends on each developer's skill, experience, and domain knowledge in crafting high-quality prompts. Thus, existing code suggestion engines often generate inaccurate and irrelevant code suggestions that are misaligned with the intended development task.

In some existing scenarios, code suggestion engines provide incorrect and misleading code suggestions due to occurrence of hallucinations, typically arising from poorly constructed or context-deficient prompts. In large-scale enterprise development environments, such inaccuracies can introduce defects in software development, compromise architectural integrity of the software, lead to deviation from software development guidelines or security requirements of the organization, and may necessitate resource-intensive debugging cycles and increased maintenance burdens of the software within the IDE. Therefore, the existing IDEs lack systems for managing and optimizing prompt engineering process during the SDLC and IDE settings.

In light of the aforementioned drawbacks, there is a need for a system and method that enables consistent, accurate, and contextually relevant prompt generation for generative artificial intelligence-based tools within an IDE. There is a need for a system and a method which reduces dependencies on prompt engineering skills of an individual. Further, there is a need for a system and a method that mitigates hallucinations from code suggestion engines due to inaccurate and insufficient prompt inputs. Furthermore, there is a need for a system and a method that improves alignment with organizational best practices and incorporates scalable and standardized prompt generating practices across the development ecosystem within the IDE.

### SUMMARY OF THE INVENTION

In various embodiments of the present invention, a system for generating one or more contextually relevant prompts for generative artificial intelligence tools is provided. The system comprises a memory storing program instructions, a processor executing instructions stored in the memory, and a prompt generation engine executed by the processor. The prompt generation engine is configured to receive a user input corresponding to a data object from a user via an interface unit. The prompt generation engine is further configured to determine one or more object characteristics of the data object based on the received user input. The one or more object characteristics is indicative of a nature of the data object. The prompt generation engine is also configured to determine a plurality of pre-determined categories from a pre-defined prompt library database based on the determined one or more object characteristics for selection by the user. The plurality of pre-determined categories is indicative of a plurality of operational domains corresponding to the data object. The prompt generation engine is configured to determine a plurality of pre-determined sub-categories from the pre-defined prompt library database based on a selected pre-determined category from amongst the plurality of pre-determined categories for selection by the user. Each of the plurality of pre-determined sub-categories is indicative of a prompt template having instructions to perform one or more operational tasks. The prompt generation engine is configured to transform a selected pre-determined sub-category from amongst the plurality of pre-determined sub-categories by inserting contextual data received from the user to perform the one or more operational tasks. The prompt generation engine is configured to generate the one or more contextually relevant prompts based on the transformed pre-determined sub-category, wherein the one or more generated prompts are sent to the generative artificial intelligence tools for execution of tasks for execution of tasks.

In various embodiments of the present invention, a method for generating one or more contextually relevant prompts for generative artificial intelligence tools is provided. The method is implemented by a processor executing instructions stored in a memory. The method comprises receiving a user input corresponding to a data object from a user. The method further comprises determining one or more object characteristics of the data object based on the received user input. The one or more object characteristics is indicative of a nature of the data object. The method also comprises determining a plurality of pre-determined categories from a pre-defined prompt library database based on the determined one or more object characteristics for selection by the user. The plurality of pre-determined categories is indicative of a plurality of operational domains corresponding to the data object. The method further comprises determining a plurality of pre-determined sub-categories from the pre-defined prompt library database based on a selected pre-determined category from amongst the plurality of pre-determined categories for selection by the user. Each of the plurality of pre-determined sub-categories is indicative of a prompt template having instructions to perform one or more operational tasks. The method comprises transforming a selected pre-determined sub-category from amongst the plurality of pre-determined sub-categories by inserting contextual data received from the user to perform the one or more operational tasks. The method also comprises generating the one or more prompts based on the transformed pre-determined sub-category, wherein the one or more generated prompts are sent to generative artificial intelligence tools for execution of tasks.

In various embodiments of the present invention, a computer program product is provided. A computer program product comprises a non-transitory computer-readable medium having computer program code stored thereon, the computer-readable program code comprising instructions that, when executed by a processor, causes the processor to receive a user input corresponding to a data object from a user via an interface unit. Further, one or more object characteristics of the data object are determined based on the received user input. The one or more object characteristics is indicative of a nature of the data object. A plurality of pre-determined categories from a pre-defined prompt library database is determined based on the determined one or more object characteristics for selection by the user. The plurality of pre-determined categories is indicative of a plurality of operational domains corresponding to the data object. A plurality of pre-determined sub-categories is determined from the pre-defined prompt library database based on a selected pre-determined category from amongst the plurality of pre-determined categories, for selection by the user. Each of the plurality of pre-determined sub-categories is indicative of a prompt template having instructions to perform one or more operational tasks. A selected pre-determined sub-category from amongst the plurality of pre-determined sub-categories is transformed by inserting contextual data received from the user to perform the one or more operational tasks. The one or more contextually relevant prompts is generated based on the transformed pre-determined sub-category, wherein the one or more generated prompts are sent to the generative artificial intelligence tools for execution of tasks for execution of tasks.

### BRIEF DESCRIPTION OF THE ACCOMPANYING DRAWINGS

The present invention is described by way of embodiments illustrated in the accompanying drawings wherein:

FIG. 1 is a block diagram of a system for generating one or more contextually relevant prompts for generative artificial intelligence based tools, in accordance with an embodiment of the present disclosure;

FIG. 2A illustrates a screenshot of a Graphical User Interface (GUI) depicting one or more object characteristics and a plurality of pre-determined categories, in accordance with an embodiment of the present disclosure;

FIG. 2B illustrates a screenshot of a GUI depicting a plurality of pre-determined sub-categories, in accordance with an embodiment of the present disclosure;

FIG. 2C illustrates a screenshot of a GUI depicting one or more prompts, in accordance with an embodiment of the present disclosure; and

FIGS. 3A and 3B illustrate a flowchart illustrating a method for generating one or more contextually relevant prompts for generative artificial intelligence based tools, in accordance with an embodiment of the present disclosure.

Further, those skilled in the art will appreciate that elements in the figures are illustrated for simplicity and may not have necessarily been drawn to scale. Furthermore, in terms of the construction of the device, the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE INVENTION

The present invention discloses a system and a method which provides for generating contextually relevant prompts for generative artificial intelligence based tools in various embodiments of the present invention. The present invention provides for generating prompts that are contextually relevant for use by code suggestion engines 124 in software development environments, which enables mitigation of hallucinations of the code suggestion engines 124 that occur due to inaccurate and insufficient prompt inputs in existing systems. Further, the present invention incorporates scalable and standardized prompt generation practices by using a pre-defined prompt library database. Also, the present invention ensures an alignment of generated prompt inputs and outputs with organizational best practices and guidelines for software development. Furthermore, the present invention enhances efficiency, accuracy, and predictability of output generated by the code suggestion engine across entire software development lifecycle (SDLC), by systematically standardizing the prompt inputs using the pre-defined prompt library database. Yet further, the present invention provides for a system and a method that minimizes dependency on prompt engineering skills of an individual.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded with the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

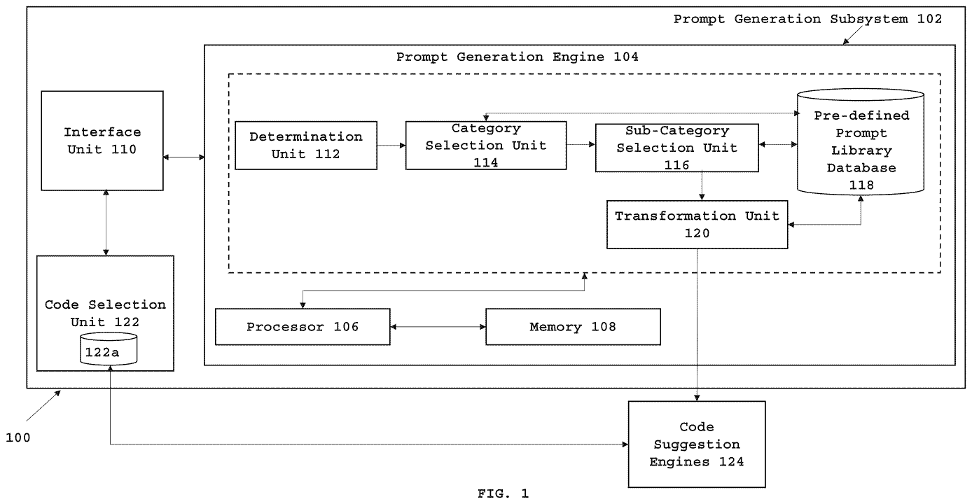

FIG. 1 is a block diagram of a system for generating one or more contextually relevant prompts for generative artificial intelligence based tools, in accordance with an embodiment of the present disclosure. Referring to FIG. 1, in an embodiment of the present invention, the system 100 comprises a prompt generation subsystem 102 (referred to as ‘subsystem 102’) and an interface unit 110. The term “prompt” refers to a structured input, instruction, or query presented as a message, symbol, or template on the interface unit 110 received from the subsystem 102 in response to an input by a user (‘user input’) within a software development environment. The user may include a developer, a system administrator, or any other stakeholder involved in software development lifecycle (SDLC) who interacts with the subsystem 102 to generate, review, or manage prompts within the software development environment. The interface unit 110 is in communication with the subsystem 102 via a communication channel (not shown). In an exemplary embodiment of the present invention, the subsystem 102 is also connected to various external data sources via the communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a local area network (LAN), a metropolitan area network (MAN) and a wide area network (WAN).

In an embodiment of the present invention, the interface unit 110 is implemented in a User Equipment (UE) via an application installed in the UE and running on an Operating System (OS) of the UE that generally defines a first active user environment. The interface unit 110 comprises a User Interface (UI) including, but is not limited to, Graphical User Interface (GUI), Command Line Interfaces (CLIs), Application Programming Interfaces (APIs), or Voice User Interfaces (VUIs). Typically, the OS displays the application through the GUI of the OS. The UI may be implemented as a web-based dashboard (‘dashboard’) which provides users with access to a comprehensive suite of features.

In various embodiments of the present invention, the interface unit 110 includes a hardware-software architecture configured to transmit the user input to the subsystem 102. The user input includes, but is not limited to, commands, keywords, menu selections, GUI interactions, mouse clicks, touchscreen interactions, or voice input which is transmitted to the subsystem 102. In an exemplary embodiment of the present invention, the interface unit 110 receives the user input via a code editor environment and triggers the subsystem 102. The code editor environment may be provided within the interface unit 110 or may be external to the interface unit 110. The subsystem 102 identifies a context of current task based on the user input. The interface unit 110 then receives an output in response to the user input from the subsystem 102. The output comprises the one or more prompts or may include intermediate results required for generation of a final prompt.

In an embodiment of the present invention, the hardware-software architecture of the interface unit 110 is configurable based on structure and modalities of interaction that the subsystem 102 supports. The hardware-software architecture of the interface unit 110 supports user interactions and the output received from the subsystem 102, thereby enhancing flexibility and usability of the system 100. In an exemplary embodiment of the present invention, the interface unit 110 utilizes input devices and software-rendered elements to manage user interactions. The interface unit 110 provides seamless interaction between the users and the subsystem 102, thereby supporting a variety of use cases from simple data entry to complex, multimodal communication in advanced applications.

In an embodiment of the present invention, the subsystem 102 may be implemented in a cloud computing architecture in which data, applications, services, and other resources are stored and delivered through shared datacenters. In an exemplary embodiment of the present invention, the functionalities of the subsystem 102 are delivered to the user as Software as a Service (SaaS) or Platform as a Service (PaaS) over a communication network.

In another embodiment of the present invention, the subsystem 102 may be implemented on a client architecture or within an application-based environment. The subsystem 102 is implemented as a plug-in option within an Integrated Development Environment (IDE) or other software development platforms. The IDE is a comprehensive software platform that consolidates coding, debugging, and testing tools, enabling seamless integration of the subsystem 102 to standardize and optimize prompt generation directly within a development workflow. Through the IDE such as Visual Studio Code, Visual Studio, IntelliJ IDEA, or similar platforms, the subsystem 102 can automatically detect contextual attributes of a software development environment including programming language, file type, or code structure. Further, the plug-in architecture allows the subsystem 102 to be deployed flexibly across a variety of development environments, supporting both on-premises and cloud-based installations. In an exemplary embodiment, the subsystem 102 operates in user's computing environment as a client-side application. The subsystem 102 is available in a computer system as a client IDE-based solution, such that all functionalities of the subsystem 102 are accessed and executed directly through the IDE installed on the user's machine. The system 100 ensures that prompt generation, contextual analysis, and interaction with generative artificial intelligence tools are managed locally within the client IDE, without reliance on external server-side processing.

In an embodiment of the present invention, the subsystem 102 includes a prompt generation engine 104 (“engine 104”), a processor 106, and a memory 108. In various embodiments of the present invention, the engine 104 comprises a plurality of units which work in conjunction with each other for carrying out automated generation of the one or more prompts. The plurality of units of the engine 104 operates via the processor 106 which is specifically programmed to execute instructions stored in the memory 108 for executing respective functionalities of the units of the engine 104 in accordance with various embodiments of the present invention. The processor 106 is a specific-purpose processor which may include a programmed microprocessor, a microcontroller, a peripheral integrated circuit element, and other devices or arrangement of devices that are capable of implementing various embodiments of the present invention.

In an embodiment of the present invention, the engine 104 comprises a determination unit 112, a category selection unit 114, a sub-category selection unit 116, a transformation unit 120. The subsystem 102 also comprises a pre-defined prompt library database 118 that is installed locally or accessed remotely, which enables seamless integration with the development workflow. In another embodiment, the pre-defined prompt library database 118 may be implemented as a plug-in within the IDE. The plurality of units is in communication with each other. In an embodiment of the present invention, the output from the subsystem 102 is used by a code selection unit 122 which can connect with generative artificial intelligence based tools such as code suggestion engines 124 that generate codes for executing various tasks.

In an embodiment of the present invention, the determination unit 112 is configured to receive the user input from the interface unit 110. The determination unit 112 determines one or more characteristics associated with a data object based on the received user input. The one or more characteristics is indicative of a nature of the data object. The data object includes, but is not limited to, textual data, documents, code snippets, record, syntax, structured data, unstructured data, datasets, and one or more character symbols including alphanumeric characters, whitespace characters, punctuation marks, and special characters. The one or more object characteristics include, but are not limited to, a programming language, an object type, a file extension, encoding format, data structure type, syntax style, a version of an active task, an intended purpose, task relevance, and security classification. For example, the determination unit 112, upon receiving the user input such as a special character like a backslash, infers that the programming language in use is Java. The determination unit 112 sends the determined one or more object characteristics as contextual information to subsequent components of the subsystem 102.

In an embodiment of the present invention, the category selection unit 114 receives the determined one or more object characteristics from the determination unit 112. The category selection unit 114 determines a plurality of pre-determined categories from the pre-defined prompt library database 118 based on the determined one or more object characteristics. The category selection unit 114 renders the plurality of pre-determined categories on the interface unit 110 via the UI. The plurality of pre-determined categories is indicative of a plurality of operational domains corresponding to the object characteristic such as design patterns, UI layers, and microservices. The user then selects a category from among the plurality of rendered pre-determined categories. For example, if the user is working on a Java-based microservices project and the determination unit 112 identifies the object characteristics as programming language Java and object type as a REST controller, the category selection unit 114 retrieves and renders the plurality of pre-determined categories such as “API Development”, “Error Handling”, “Security”, and “Logging” from the pre-defined prompt library database 118 based on the contextual information received from the determination unit 112. The plurality of pre-determined categories is then displayed to the user via the interface unit 110. The user then selects a pre-defined category from amongst the plurality of pre-determined categories based on a current task in the development workflow. Upon selection of the pre-defined category from amongst the plurality of pre-determined categories such as selection of “API Development” by the user, the category selection unit 114 sends the selected pre-determined category to the sub-category selection unit 116. The category selection unit 114 aligns the plurality of rendered pre-determined categories contextually with both intent of the user and organizational best practices.

In an embodiment of the present invention, the category selection unit 114 is further configured to receive user feedback and performance data associated with the plurality of rendered pre-determined categories. The category selection unit 114 updates the plurality of pre-determined categories present within the pre-defined prompt library database 118 based on the user feedback and the performance data. In an exemplary embodiment of the present invention, the category selection unit 114 saves the custom categories provided by the user within the pre-defined prompt library database 118.

In an embodiment of the present invention, the sub-category selection unit 116 receives the selected pre-determined category from the category selection unit 114. The sub-category selection unit 116 determines a plurality of pre-determined sub-categories from the pre-defined prompt library database 118 based on the selected pre-determined category. The sub-category selection unit 116 is configured to render the plurality of pre-determined sub-categories, for selection by the user on the interface unit 110 via the UI. Each of the plurality of pre-determined sub-categories is indicative of a prompt template having instructions to perform one or more operational tasks within the development workflow. The prompt template aligns the generated prompts with syntax and standards required by a code suggestion engine 124. The prompt template provides a structured and standardized format for submitting instructions to the code suggestion engine 124. The prompt template includes one or more placeholder fields which is dynamically populated with contextual data provided by the user to ensure that each of the generated prompt is in accordance with specific requirements of the development workflow. The code suggestion engine (124) processes the received prompts and produces code snippets and relevant code recommendations that assist the user in performing specific development tasks within the software development environment. A generative artificial intelligence model is integrated with the code suggestion engine 124 for automated execution of prompts to generate the code snippets and code recommendations. In an exemplary embodiment of the present invention, the code suggestion engine 124 is embedded within the IDE and is accessed by the user through the GUI provided by the interface unit 110.

In an embodiment of the present invention, the user selects a sub-category from amongst the plurality of rendered pre-determined sub-categories. For example, if the user has selected the category “API Development” from the plurality of pre-determined rendered categories, the sub-category selection unit 116 retrieves and displays the plurality of pre-determined sub-categories such as “Create REST Endpoint”, “Implement Input Validation”, “Configure API Security”, and “Document API Methods” from the pre-defined prompt library database 118. The plurality of pre-determined sub-categories is rendered to the user via the interface unit 110, allowing the user to further specify the one or more operational tasks the user wants to perform. If the user selects “Create REST Endpoint”, the sub-category selection unit 116 then generates and renders a contextually relevant, standardized prompt such as a template or instruction for defining a new RESTful API endpoint in the programming language determined by the determination unit 112, ensuring that the one or more generated prompt aligns with organizational best practices and specific requirements of the current task in the development workflow. The plurality of units therefore streamlines the prompt generation process, reduces ambiguity, and supports the user in efficiently completing the task within the IDE.

In an embodiment of the present invention, the sub-category selection unit 116 is further configured to receive the user feedback and the performance data associated with the plurality of rendered pre-determined sub-categories. The sub-category selection unit 116 updates the plurality of pre-determined sub-categories present within the pre-defined prompt library database 118 based on the user feedback and the performance data. In an exemplary embodiment of the present invention, the sub-category selection unit 116 saves the custom sub-categories provided by the user within the pre-defined prompt library database 118.

In an embodiment of the present invention, the pre-defined prompt library database 118 is a central repository comprising the plurality of pre-determined categories and the plurality of pre-determined sub-categories directly provided within the IDE. Each of the plurality of pre-determined categories and the plurality of pre-determined sub-categories is designed to address the one or more operational tasks within the SDLC. For example, the pre-defined prompt library database 118 includes a plurality of prompt templates that cover entire SDLC from analysis to coding, testing, and deployment, minimizing ambiguity and enhancing effectiveness in generating accurate code. In a use case scenario, the pre-defined prompt library database 118 provides the plurality of prompt templates during a large-scale refactoring initiative to ensure consistency and adherence to the organizational policy.

In an exemplary embodiment of the present invention, the pre-defined prompt library database 118 stores the plurality of pre-determined categories, the plurality of pre-determined sub-categories, or the plurality of prompt templates in the form of a JSON file. Each programming language supported by the subsystem 102, such as Java, .NET, Angular, and React has a pre-bundled JSON file. The pre-bundled JSON file includes the plurality of pre-determined categories, the plurality of pre-determined sub-categories, or the plurality of prompt templates. The pre-defined prompt library database 118 supports multiple programming languages and IDEs therefore making the pre-defined prompt library database 118 highly versatile by accommodating diverse development environments within large organizations. Further, the users can customize and add prompts by providing a specific path to corresponding JSON file. The pre-defined prompt library database 118 therefore also stores custom prompts determined by individual users. By allowing the users to fetch the custom prompts from customizable JSON paths and providing language-specific libraries, the pre-defined prompt library database 118 enhances usability, adaptability, and consistency across diverse development environments.

In a use-case scenario, the pre-defined prompt library database 118 supports TypeScript to ensure seamless integration with Visual Studio Code (VSCode) and provides support for the users using VSCode as primary IDE. The pre-defined prompt library database 118 allows the users working in TypeScript to access the plurality of pre-determined categories, the plurality of pre-determined sub-categories, or the plurality of prompt templates directly within VSCode, therefore ensuring consistency with the organization policy. In another use case scenario, the pre-defined prompt library database 118 supports Java for the users working in IntelliJ environment, thereby reducing manual effort, minimizing ambiguity, and aligning with organizations best practices.

In an embodiment of the present invention, the pre-defined prompt library database 118 further maintains a record of favorite prompts associated with individual user profiles to quickly retrieve frequently used prompts. In an embodiment of the present invention, the pre-defined prompt library database 118 is a polyglot persistence layer which utilizes different types of data storage formats to efficiently manage and organize contents. Each section of the pre-defined prompt library database 118 is assigned to different data types such as the plurality of pre-determined categories, the plurality of pre-determined sub-categories, the custom prompts, and the favorite prompts, thereby ensuring that the users can quickly retrieve the one or more prompts aligned with organization's best practices which aids in mitigating a risk of hallucinations produced by the code suggestion engine.

In an embodiment of the present invention, the pre-defined prompt library database 118 supports integration with version control systems such as Git®, Subversion®, or similar systems. The prompt generation engine (104) is configured to update the plurality of pre-determined categories, the plurality of pre-determined sub-categories, and a plurality of prompt templates pre-stored within the pre-defined prompt library database 118 based on the user feedback and performance data. The pre-defined prompt library database 118 is therefore configured such that changes in the plurality of pre-determined categories, the plurality of pre-determined sub-categories, and the plurality of prompt templates are tracked, versioned, and auditable. Therefore, any update, addition, or deletion to the pre-defined prompt library database 118 is recorded. The pre-defined prompt library database 118 further allows stakeholders or development teams to roll back to previous versions of the plurality of the plurality of pre-determined categories, the plurality of pre-determined sub-categories, and the plurality of prompt templates, if required. The pre-defined prompt library database 118 is configured to integrate with collaborative platforms such as GitHub®, GitLab®, Bitbucket®, or enterprise collaboration tools which enables the development teams to work together more effectively by allowing the development teams to share and manage the plurality of the plurality of pre-determined categories, the plurality of pre-determined sub-categories, and the plurality of prompt templates in the central repository.

In an embodiment of present invention, the pre-defined prompt library database 118 supports advanced features such as analytics and usage tracking, which allow for continuous improvement of prompt quality and relevance based on at least one of the user feedback and the performance data. The pre-defined prompt library database 118 is configured to continuously log and analyze prompt usage within the software development environments to improve and refine prompts. Specifically, the pre-defined prompt library database 118 systematically records operational data each time the plurality of pre-determined categories, the plurality of pre-determined sub-categories, or the plurality of prompt templates is accessed, selected, or updated by the user. The pre-defined prompt library database 118 captures one or more prompt usage metrics such as frequency of usage for specific prompts, context in which the prompts are employed, the user feedback, and outcomes, or effectiveness of the generated code suggestions. The pre-defined prompt library database 118 analyses the one or more prompt usage metrics to refine and improve the pre-defined prompt library database 118 over time. For example, prompts that are frequently used and receive positive feedback are highlighted or prioritized, making them more accessible to other users. Conversely, prompts that are rarely used or eventually results in poor code suggestions are reviewed, updated, or removed. Additionally, patterns in user behavior and the user feedback triggers the subsystem 102 for creation of new prompts or modification of existing prompts available in the pre-defined prompt library database 118 to align with the organizational policies.

Furthermore, the pre-defined prompt library database 118 can be integrated with Continuous Integration/Continuous Deployment (CI/CD) pipelines to automate prompt standardization checks during code review and deployment phase. System administrators or subject matter experts (SMEs) can monitor utilization of the one or more prompts across teams, identify popular or underused prompt templates, and refine the pre-defined prompt library database 118 to align with organizational objectives. In an embodiment of the present invention, the pre-defined prompt library database 118 is pre-defined, customizable, or dynamically extensible to accommodate evolving organizational requirements. The structured and extensible nature of the pre-defined prompt library database 118 therefore provides a robust foundation for consistent, efficient, and high-quality prompt generation.

In an embodiment of the present invention, the transformation unit 120 is configured to transform the selected pre-determined sub-category from amongst the plurality of pre-determined sub-categories retrieved from the pre-defined prompt library database 118 by inserting the contextual data received from the user to perform the one or more operational tasks. For example, when the user is working within the IDE and selects the sub-category “Create REST Endpoint” under the category “API Development”, the transformation unit 120 retrieves a standard prompt template for creating a REST endpoint from the pre-defined prompt library database 118. The user then provides the contextual data such as desired HTTP method (e.g., POST), endpoint path (e.g., /users), and expected input parameters (e.g., userId, userName). The transformation unit 120 automatically inserts the contextual data into the prompt template, resulting in generation of a prompt such as “Generate a Java Spring Boot REST controller with a POST endpoint at/users that accepts userId and userName as input parameters and returns a JSON response with the created user details. Ensure input validation and include appropriate error handling as per organizational best practices”. The generated prompt is then sent to generative artificial intelligence tools for execution of tasks. For example, the generated prompt is sent to the code suggestion engine 124 which generates accurate code snippets and relevant code suggestions aligned with a user intent and organization's coding standards based on the generated prompt. The transformation unit 120 not only standardizes prompt generation but also reduces ambiguity, minimizes risks of hallucinations, and ensures consistency across development teams within the SDLC.

In an embodiment of the present invention, the code selection unit 122 is configured to connect with code suggestion engines 124 such as GitHub Copilot®, Amazon Q®, and other proprietary or open-source tools, and obtain a plurality of code snippets from the code suggestion engine 124 via the interface unit 110 based on the one or more generated prompts. The code selection unit 122 selects a code snippet from amongst the plurality of code snippets based on a plurality of pre-defined criteria. The plurality of pre-defined criteria includes, but is not limited to, relevance of each of the plurality of code snippets against the one or more generated prompt, accuracy of each of the plurality of code snippets, and adherence of each of the plurality of code snippets against an organizational policy. The code selection unit 122 then renders the selected code snippet via the interface unit 110. For example, if a user working within the IDE generates a prompt like “Generate a Java method to validate an email address input that matches standard email format and returns a boolean result”, the code suggestion engine 124 then provides several candidate snippets: one using regular expressions for validation, another checking only for the presence of “@“and”.”, and a third utilizing an external library. The code selection unit 122 assesses the candidate code snippets against the plurality of pre-defined criteria. In the present use-case scenario, the code snippet using regular expressions is selected which is both accurate and compliant, whereas the other code snippets may be less suitable due to either insufficient validation or organizational policy conflicts. Once the code snippet is selected, it is rendered to the user via the interface unit 110 for integration into a main code for execution of tasks. Further, the user can also review and refine the selected code snippet before integrating the selected code snippet into a main code to ensure that a task is executed which is aligned with the user intent.

In an exemplary embodiment of the present invention, the code selection unit 122 is also configured to select one or more technical artefacts such as flowcharts, algorithms, and similar resources based on the one or more generated prompts by connecting to databases, libraries, or engines that store or retrieve the technical artefacts. For example, when a user specifies a need for a particular algorithm or a visual representation of a process, the code selection unit 122 can query relevant databases or libraries that contain pre-defined flowcharts or algorithmic templates. The code selection unit 122 then evaluates the retrieved technical artefacts against the plurality of pre-defined criteria. The code selection unit 122, by supporting selection from among the pre-defined flowcharts or the algorithmic templates, enhances utility for the users who require not only executable code but also supporting documentation or visual aids to better understand, communicate, or implement a solution.

In an embodiment of the present invention, the code selection unit 122 is also configured to store one or more selected code snippets from amongst the plurality of code snippets based on a frequency of utilization of the one or more generated prompts in a code database 122a, thereby improving efficiency in code retrieval and promotes uniformity in code quality. Furthermore, the code selection unit 122 allows the users to create, store, and manage custom code snippets via the code database 122a thereby enabling quick access to frequently used code templates.

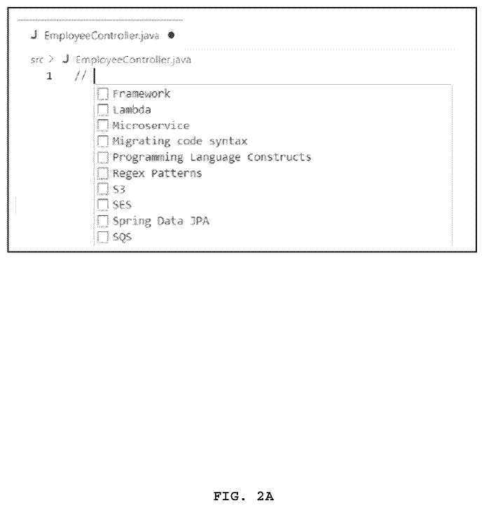

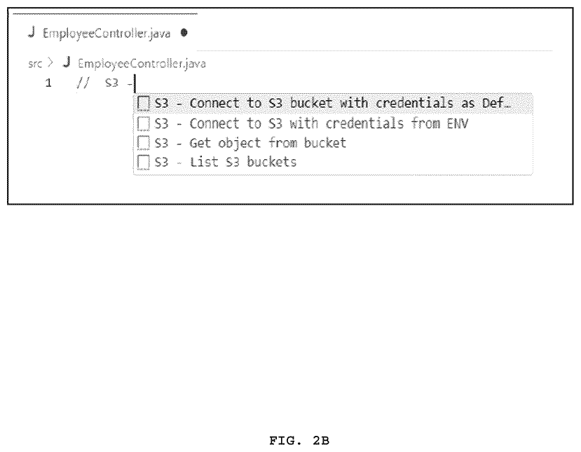

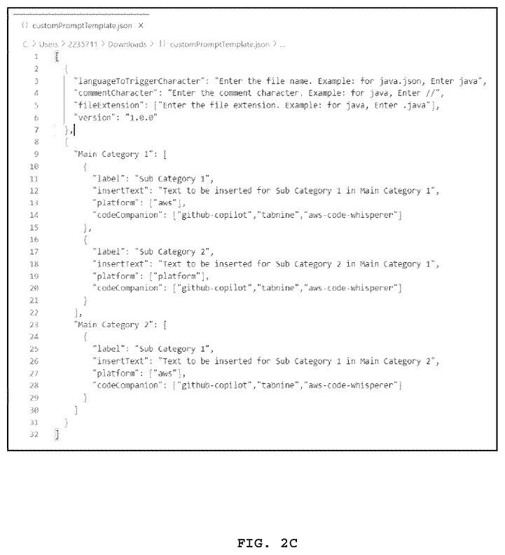

FIG. 2A illustrates a screenshot of a GUI depicting the one or more object characteristics and rendering the plurality of pre-determined categories, in accordance with an embodiment of the present disclosure. FIG. 2B illustrates a screenshot of a GUI depicting the plurality of pre-determined sub-categories, in accordance with an embodiment of the present disclosure. FIG. 2C illustrates a screenshot of a GUI depicting the one or more prompts, in accordance with an embodiment of the present disclosure. FIGS. 2A, 2B, and 2C are discussed together, for the sake of clarity and conciseness. The examples depicted in FIGS. 2A, 2B, and 2C are provided solely for illustrative and explanatory purposes. The embodiment described therein is not intended to limit the scope of the present disclosure in any manner. Various modifications, alternatives, and equivalent configurations may be implemented without departing from the scope of the present invention.

Referring to FIG. 2A, the interface unit 110 is configured to receive user input. In the illustrated example, the user enters a special character sequence “//” into the GUI. The determination unit 112 analyzes the user input and determines the one or more object characteristics associated with received special character sequence. In the present example, the determination unit 112 identifies the special character sequence “//” as a language-specific indicator commonly used for commenting in the Java programming language. Based on the determination, the category selection unit 114 determines, from the pre-defined prompt library database 118, the plurality of pre-determined categories corresponding to the Java programming language. The plurality of pre-determined categories determined by the category selection unit 114, is rendered via the interface unit 110 and presented to the user for selection. As shown in FIG. 2A, the plurality of pre-determined categories includes “Framework,” “Lambda,” “Microservice,” “Migrating code syntax,” “Programming Language Constructs,” “Regex Patterns,” “S3,” “SES,” “Spring Data JPA,” and “SQS.” For selection after which the subsystem 102 proceeds to the subsequent step. In the present example, the selected pre-defined category is “S3”.

Referring to FIG. 2B, once the user selects the pre-defined category “S3”, the sub-category selection unit 116 accesses the pre-defined prompt library database 118 and determines the plurality of pre-determined sub-categories associated with the selected pre-defined category from the pre-defined prompt library database 118. In the present illustrated example, the plurality of pre-determined sub-categories include “Connect to S3 bucket with credentials as DefaultAWSCredentialsProviderChain”, “Connect to S3 with credentials from ENV”, “Get object from bucket”, and “List S3 bucket”. The GUI displays the plurality of pre-determined sub-categories to the user via the interface unit 110. Upon receiving the user's selection from the plurality of pre-determined sub-categories, the sub-category selection unit 116 displays a corresponding prompt template on the GUI via the interface unit 110.

Referring to FIG. 2C, the determination unit 112 displays the one or more object characteristics such as programming language, character sequence used to trigger the programming language, file extension, and version information, on the GUI via the interface unit 110. The one or more characteristics provide metadata that enable the subsystem 102 to modify a prompt generation process with respect to a specific development environment and current task. The category selection unit 114 further renders the selected pre-defined category as ‘main category’ on the interface unit 110, thereby maintaining contextual continuity and clearly indicating the user's progression through prompt-generation workflow.

In the illustrated example, the transformation unit 120 then receives the contextual data such as a “label”, an “insert text” value, a “platform”, and a “code companion”, provided by the user. The “label” represents a name or identifier of the selected pre-defined sub-category, enabling the sub-category selection unit 116 to internally map the selected pre-defined sub-category to a corresponding prompt template. The transformation unit 120 replaces the one or more placeholder fields present within the prompt template by inserting the contextual data received from the user. The one or more placeholder fields include tokens such as “insertText” to insert text value or the contextual data provided by the user, the “platform” indicates an execution or infrastructure environment for which a generated prompt is intended. In the present example, the subsystem 102 supports multiple platform identifiers, including, but is not limited to, “generic”, referring to a cloud-agnostic or environment-neutral context not tied to any specific cloud provider; “AWS” (Amazon Web Services) representing cloud infrastructure, compute, storage, and developer tooling provided by Amazon Web Services; “Azure” (Microsoft Azure) representing cloud computing services and infrastructure offered by Microsoft Azure; and “GCP” (Google Cloud Platform), referring to cloud services, APIs, and compute infrastructure provided by Google Cloud Platform. The platform identifiers allow the transformation unit 120 to modify the generated prompt corresponding to cloud-specific libraries, APIs, authentication mechanisms, or resource-handling patterns associated with the platform determined by the user. The subsystem 102 thus ensures that a resulting prompt not only reflects organizational best practices but also aligns with platform-specific implementation requirements. The “CodeCompanion” represents an array that specifies code suggestion engine 124 such as GitHub Copilot®, Amazon Q® Developer, Tabnine®, or other AI-driven systems, for which the generated prompt should be displayed or optimized. The subsystem 102 ensures that the generated prompt is compatible with operational characteristics, input expectations, and optimization heuristics of the code suggestion engine 124 selected by the user. Once all the contextual parameters are collected from the user, the transformation unit 120 integrates the contextual data within the prompt template by performing appropriate substitutions, insertions, or structural modifications. The transformation unit 120 then produces the one or more prompts that are contextually relevant, technically accurate, optimized, and aligned with organization's pre-defined standards for prompt engineering. The one or more prompts are subsequently rendered via the interface unit 110 for immediate use by the user within the IDE.

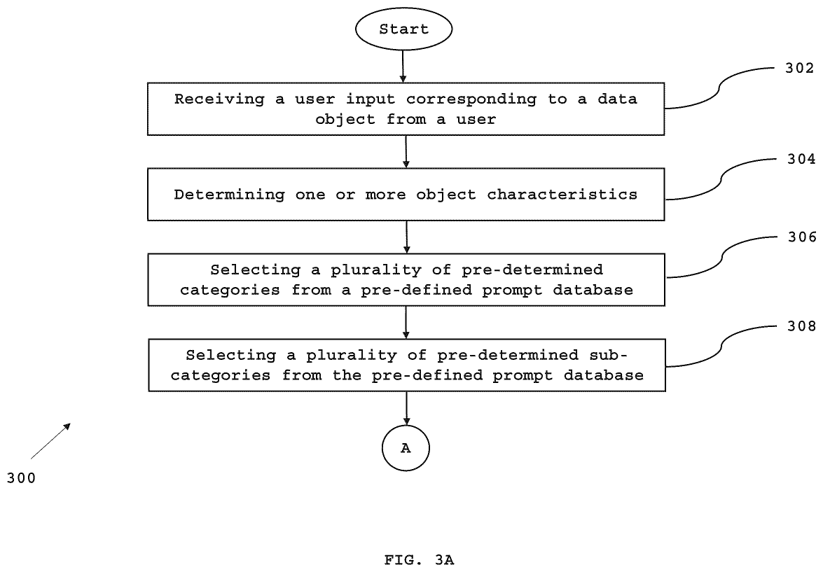

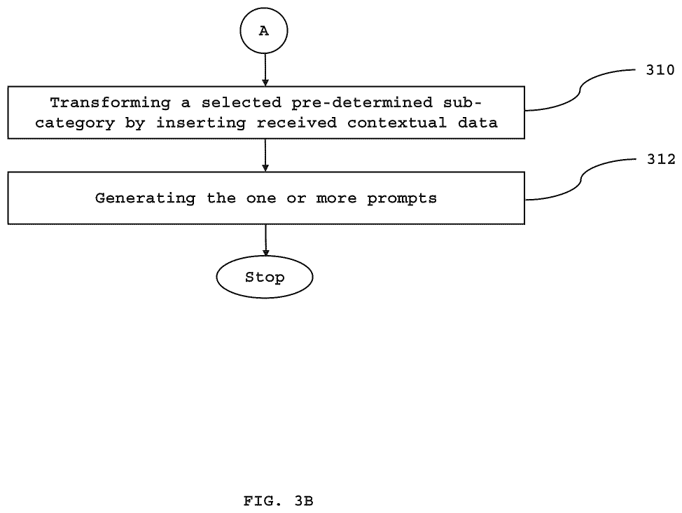

FIGS. 3A and 3B illustrate a flowchart depicting a method 300 for generating one or more prompts, in accordance with an embodiment of the present disclosure.

At step 302, a user input corresponding to a data object is received from a user. In an embodiment of the present invention, the user input is received via an interface unit 110. The received user input includes, but is not limited to, commands, keywords, menu selections, GUI interactions, unstructured prompts, mouse clicks, touchscreen interactions, or voice input, which is transmitted to the subsystem 102. The data object comprises one or more of textual data, documents, code snippets, record, syntax, structured data, unstructured data, datasets, and one or more character symbols including alphanumeric characters, whitespace characters, punctuation marks, and special characters.

At step 304, one or more object characteristics of the data object are determined. In an embodiment of the present invention, the one or more object characteristics are determined based on the received user input. The one or more object characteristics are indicative of a nature of the data object. The one or more object characteristics include, but are not limited to, a programming language, an object type, a file extension, encoding format, data structure type, syntax style, a version of an active task, an intended purpose, task relevance, and security classification.

At step 306, a plurality of pre-determined categories from a pre-defined prompt library database 118 is determined. In an embodiment of the present invention, the plurality of pre-determined categories is determined based on the determined one or more object characteristics. The plurality of pre-determined categories is rendered on a Graphical User Interface (GUI) via the interface unit 110, for selection by the user. The plurality of pre-determined categories is indicative of a plurality of operational domains corresponding to the data object, such as design patterns, UI layers, and microservices.

At step 308, a plurality of pre-determined sub-categories from the pre-defined prompt library database 118 is determined. In an embodiment of the present invention, the plurality of pre-determined sub-categories is determined based on a selected pre-determined category from amongst the plurality of pre-determined categories. The plurality of pre-determined sub-categories is rendered for selection by the user. Each of the plurality of pre-determined sub-categories is indicative of a prompt template having instructions to perform one or more operational tasks. For example, if the user has selected the category “API Development” from the plurality of pre-determined rendered categories, the sub-category selection unit 116 retrieves and displays the plurality of pre-determined sub-categories such as “Create REST Endpoint”, “Implement Input Validation”, “Configure API Security”, and “Document API Methods” from the pre-defined prompt library database 118. The plurality of pre-determined categories, the plurality of pre-determined sub-categories, and the plurality of the plurality of pre-determined categories, the plurality of pre-determined sub-categories, and a plurality of prompt templates pre-stored within the pre-defined prompt library database 118 is updated based on at least one of user feedback and performance data.

At step 310, a selected pre-determined sub-category from amongst the plurality of pre-determined sub-categories is transformed by inserting contextual data received from the user to perform the one or more operational tasks. In an embodiment of the present invention, the one or more operational tasks represent a user intent in accordance with a development workflow within an Integrated Development Environment (IDE).

At step 312, one or more prompts is generated based on the transformed pre-determined sub-category. In an embodiment of the present invention, the one or more prompts are configured for execution of one or more operational tasks by generative artificial intelligence (AI based tools. The one or more generated prompts are rendered on the GUI for execution of the one or more operational tasks by the generative artificial intelligence based tools.

In an example, the generative artificial based tool is a code suggestion engine 124 which generates code snippets and accurate and relevant code suggestions aligned with a user intent and organization's coding standards based on the generated prompt. The code selection unit 122 receives the code snippets and selects a code snippet based on a plurality of pre-defined criteria. The plurality of pre-defined criteria comprises relevance of each of the plurality of code snippets against the one or more generated prompt, accuracy of each of the plurality of code snippets, and adherence of each of the plurality of code snippets against an organizational policy. The selected code snippet is rendered via the interface unit 110 for integration into a main code for execution of tasks. Further, the user can also review and refine the selected code snippet before integrating the selected code snippet into a main code to ensure that a task is executed which is aligned with the user intent. One or more selected code snippets from amongst the plurality of code snippets is stored based on a frequency of utilization of the one or more generated prompts.

Advantageously, in accordance with various embodiments of the present invention, the present invention provides for a system and a method for generation of prompts that is consistent, accurate, and contextually relevant within software development environment. The present invention reduces dependency on prompt engineering skills of an individual user by leveraging the pre-defined prompt library database 118, thereby ensuring uniformity and adherence to organizational best practices across software development teams. The present invention mitigates hallucination risks and inaccuracies in code suggestions. Furthermore, the present invention provides for a system and a method that facilitates continuous improvement and scalability of the pre-defined prompt library database 118 by incorporating user feedback and performance data to refine and update the plurality of pre-determined categories, the plurality of pre-determined categories, and the plurality of prompt templates over time. Additionally, the present invention enhances collaboration and efficiency by supporting integration with version control systems and enabling seamless sharing and management of plurality of prompt templates across teams and projects within an organization.

The present invention may suitably be embodied as a computer program product. The method described herein is typically implemented as a computer program product, comprising a set of program instructions which is executed by the processor 106. The set of program instructions may be a series of computer readable codes stored on a tangible medium such as a computer readable storage medium, for example, diskette, CD-ROM, ROM, flash drives or hard disk, or maybe transmittable via a modem or other interface device over a tangible medium. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for generating one or more contextually relevant prompts for generative Artificial Intelligence (AI) tools, the system comprises:
a memory storing program instructions;
a processor executing instructions stored in the memory; and
a prompt generation engine executed by the processor and configured to:
receive a user input corresponding to a data object from a user via an interface unit;
determine one or more object characteristics of the data object based on the received user input, the one or more object characteristics are indicative of a nature of the data object;
determine a plurality of pre-determined categories from a pre-defined prompt library database based on the determined one or more object characteristics for selection by the user, wherein the plurality of pre-determined categories is indicative of a plurality of operational domains corresponding to the data object;
determine a plurality of pre-determined sub-categories from the pre-defined prompt library database based on a selected pre-determined category from amongst the plurality of pre-determined categories for selection by the user, wherein each of the plurality of pre-determined sub-categories is indicative of a prompt template having instructions to perform one or more operational tasks;
transform a selected pre-determined sub-category from amongst the plurality of pre-determined sub-categories by inserting contextual data received from the user to perform the one or more operational tasks; and
generate one or more contextually relevant prompts based on the transformed pre-determined sub-category, wherein the one or more generated prompts are sent to the generative AI tools for execution of tasks.

2. The system as claimed in claim 1, wherein the prompt generation engine comprises a determination unit executed by the processor and is configured to:
receive the user input comprising one or more of commands, keywords, menu selections, GUI interactions, unstructured prompts, mouse clicks, touchscreen interactions, and voice input; and
determine the object characteristics associated with the data object comprising one or more of textual data, documents, code snippets, record, syntax, structured data, unstructured data, datasets, and one or more character symbols including alphanumeric characters, whitespace characters, punctuation marks, and special characters, wherein the object characteristics comprise one or more of a programming language, an object type, a file extension, encoding format, data structure type, syntax style, a version of an active task, an intended purpose, task relevance, and security classification.

3. The system as claimed in claim 1, wherein the prompt generation engine comprises a category selection unit executed by the processor and is configured to determine the pre-determined categories that are contextually relevant to intent of the user and organizational best practices, and wherein the operational domains include design patterns, UI layers, and microservices, and wherein the category selection unit sends the selected pre-determined category to a sub-category selection unit.

4. The system as claimed in claim 1, wherein the prompt generation engine comprises a sub-category selection unit executed by the processor and is configured to determine the plurality of pre-determined sub-categories, and wherein the prompt template aligns the generated prompts with syntax and standards required by a code suggestion engine and provides a structured and standardized format for submitting instructions to the code suggestion engine, and wherein the prompt template includes one or more placeholder fields which is dynamically populated with contextual data provided by the user to ensure that each of the generated prompt is in accordance with specific requirements of the development workflow.

5. The system as claimed in claim 1, wherein the prompt generation engine is configured to update the plurality of pre-determined categories, the plurality of pre-determined sub-categories, and a plurality of prompt templates pre-stored within the pre-defined prompt library database based on user feedback and performance data.

6. The system as claimed in claim 1, wherein the prompt generation engine comprises a transformation unit executed by the processor and is configured to generate the prompts which are standardized prompts and are sent to code suggestion engines for generating code snippets and code recommendations, and wherein the transformation unit reduces ambiguity, minimizes risks of hallucinations, and ensures consistency across development teams within a software development lifecycle.

7. The system as claimed in claim 1, wherein the system comprises a code selection unit executed by the processor and is configured to:
obtain a plurality of code snippets from a code suggestion engine via the interface unit based on the one or more generated prompts;
select a code snippet from amongst the plurality of code snippets based on a plurality of pre-defined criteria, the plurality of pre-defined criteria comprises relevance of each of the plurality of code snippets against the one or more generated prompt, accuracy of each of the plurality of code snippets, and adherence of each of the plurality of code snippets against an organizational policy; and
render the selected code snippet via the interface unit.

8. The system as claimed in claim 7, wherein the code selection unit stores one or more selected code snippets from amongst the plurality of code snippets in a code database based on a frequency of utilization of the one or more generated prompts.

9. A method of generating one or more contextually relevant prompts for generative Artificial Intelligence (AI) tools, the method is implemented by a processor executing instructions stored in a memory, the method comprises:
receiving a user input corresponding to a data object from a user;
determining one or more object characteristics of the data object based on the received user input, the one or more object characteristics are indicative of a nature of the data object;
determining a plurality of pre-determined categories from a pre-defined prompt library database based on the determined one or more object characteristics for selection by the user, wherein the plurality of pre-determined categories is indicative of a plurality of operational domains corresponding to the data object;
determining a plurality of pre-determined sub-categories from the pre-defined prompt library database based on a selected pre-determined category from amongst the plurality of pre-determined categories for selection by the user, wherein each of the plurality of pre-determined sub-categories is indicative of a prompt template having instructions to perform one or more operational tasks;
transforming a selected pre-determined sub-category from amongst the plurality of pre-determined sub-categories by inserting contextual data received from the user to perform the one or more operational tasks; and
generating one or more contextually relevant prompts based on the transformed pre-determined sub-category, wherein the one or more generated prompts are sent to the generative AI tools for execution of tasks.

10. The method as claimed in claim 9, wherein the user input comprises one or more of commands, keywords, menu selections, GUI interactions, unstructured prompts, mouse clicks, touchscreen interactions, and voice input, and wherein the data object comprises one or more of textual data, documents, code snippets, record, syntax, structured data, unstructured data, datasets, and one or more character symbols including alphanumeric characters, whitespace characters, punctuation marks, and special characters, and wherein the one or more object characteristics comprises one or more of a programming language, an object type, a file extension, encoding format, data structure type, syntax style, a version of an active task, an intended purpose, task relevance, and security classification.

11. The method as claimed in claim 9, wherein the prompt templates align the generated prompts with syntax and standards required by a code suggestion engine and provides a structured and standardized format for submitting instructions to the code suggestion engine, and wherein the prompt template includes one or more placeholder fields which is dynamically populated with contextual data provided by the user to ensure that each of the generated prompt is in accordance with specific requirements of the development workflow.

12. The method as claimed in claim 9, wherein the step of transforming comprises generating the prompts which are standardized prompts and sending the generated prompts to code suggestion engines for generating code snippets and code recommendations.

13. The method as claimed in claim 9, wherein the method further comprises using the generated prompts to obtain a plurality of code snippets from a code suggestion engine via the interface unit; electing a code snippet from amongst the plurality of code snippets based on a plurality of pre-defined criteria, the plurality of pre-defined criteria comprises relevance of each of the plurality of code snippets against the one or more generated prompt, accuracy of each of the plurality of code snippets, and adherence of each of the plurality of code snippets against an organizational policy; and rendering the selected code snippet via the interface unit, and wherein the one more selected code snippets from amongst the plurality of code snippets are stored in a code database based on a frequency of utilization of the one or more generated prompts.

14. The method as claimed in claim 9, wherein the method comprises:
updating the plurality of pre-determined categories, the plurality of pre-determined sub-categories, and a plurality of prompt templates pre-stored within the pre-defined prompt library database based on user feedback and performance data.

15. A computer program product comprising:
a non-transitory computer-readable medium having computer program code stored thereon, the computer-readable program code comprising instructions that, when executed by a processor, causes the processor to:
receive a user input corresponding to a data object from a user via an interface unit;
determine one or more object characteristics of the data object based on the received user input, the one or more object characteristics are indicative of a nature of the data object;
determine a plurality of pre-determined categories from a pre-defined prompt library database based on the determined one or more object characteristics for selection by the user, wherein the plurality of pre-determined categories is indicative of a plurality of operational domains corresponding to the data object;
determine a plurality of pre-determined sub-categories from the pre-defined prompt library database based on a selected pre-determined category from amongst the plurality of pre-determined categories, for selection by the user, wherein each of the plurality of pre-determined sub-categories is indicative of a prompt template having instructions to perform one or more operational tasks;
transform a selected pre-determined sub-category from amongst the plurality of pre-determined sub-categories by inserting contextual data received from the user to perform the one or more operational tasks; and
generate one or more contextually relevant prompts based on the transformed pre-determined sub-category, wherein the one or more generated prompts are sent to the generative AI tools for execution of tasks.
